(19) United States
(12) Patent Application Publication
(10) Pub. No.: US 2026/0212017 A1
(43) Pub. Date: Jul. 23, 2026

(54) DETECT AND REUSE SCAN RESULTS TO OPTIMIZE SECURE SOFTWARE SUPPLY CHAIN

(71) Applicant: INTERNATIONAL BUSINESS MACHINES CORPORATION, ARMONK, NY (US)

(72) Inventors: LAKSHMI PRIYA SHANMUGAM, Bangalore (IN); Sahasrabdi Bhattacherya, Kharagpur (IN); Gyan Gautam, Bangalore (IN); Philippe Mulet, Saint-Nazaire (FR); PIYUSH MUNDRA, Bengaluru (IN); Anamika Agrawal, Mahendragarh (IN); Sayan Chakraborty, Bhadreswar (IN)

(21) Appl. No.: 19/035,112

(22) Filed: Jan. 23, 2025

(51) Int. Cl. G06F 21/57; G06F 8/60

(52) U.S. Cl. CPC G06F 21/57; G06F 8/60; G06F 2221/033

(57) ABSTRACT

An embodiment for detecting and reusing scan results to optimize a secure software supply chain is provided. The embodiment may include receiving a pull request. The embodiment may also include executing a first scan of a first content item as part of a first pipeline. The embodiment may further include generating a first unique ID for the first content item. The first unique ID is correlated with collected evidence from the first scan. The embodiment may also include generating a second unique ID for a second content item as part of a second pipeline. The embodiment may further include based on determining evidence for the second content item exists, validating the evidence for the second content item. The embodiment may also include, based on determining the evidence for the second content item is valid, skipping a second scan for the second content item in the second pipeline.

### BACKGROUND

The present invention relates generally to the field of computing, and more particularly to a system for detecting and reusing scan results to optimize a secure software supply chain.

Continuous integration (CI) and continuous deployment (CD) are a set of DevOps practices aimed at automating and streamlining the software development lifecycle such as the build, test, and deploy phases. DevSecOps is an extension of the DevOps concept which incorporates security practices/checks into the entire software development lifecycle. Software developers normally commit code multiple times a day while developing a feature or fixing a bug. Automated checks are also in place, such as scans to verify third party libraries/dependencies.

### STATEMENT REGARDING PRIOR DISCLOSURES BY THE INVENTOR OR A JOINT INVENTOR

The following disclosure is submitted under 35 U.S.C. § 102(b)(1)(A):
DISCLOSURE: Invention has been made public by implementing the invention as part of the IBM Cloud® (IBM and all IBM-based trademarks and logos are trademarks or registered trademarks of International Business Machines Corporation and/or its affiliates) DevSecOps pipelines as of Sep. 11, 2024.

### SUMMARY

According to one embodiment, a method, computer system, and computer program product for detecting and reusing scan results to optimize a secure software supply chain is provided. The embodiment may include receiving a pull request from a user. The embodiment may also include executing a first scan of a first content item corresponding to a first commit as part of a first pipeline. The embodiment may further include generating a first unique ID for the scanned first content item, where the first unique ID is correlated with collected evidence from the first scan. The embodiment may also include, upon a merge of the pull request, generating a second unique ID for a second content item corresponding to a second commit as part of a second pipeline. The embodiment may further include based on determining evidence for the second content item exists based on the first unique ID and the second unique ID, validating the evidence for the second content item based on one or more validation factors. The embodiment may also include, based on determining the evidence for the second content item is valid, skipping a second scan for the second content item in the second pipeline.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIGS. 2A and 2B illustrate an operational flowchart for detecting and reusing scan results to optimize a secure software supply chain in a software supply chain optimization process according to at least one embodiment.

FIG. 3 is an exemplary diagram depicting an interaction between solution components of the process in FIGS. 2A and 2B according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for detecting and reusing scan results to optimize a secure software supply chain. The following described exemplary embodiments provide a system, method, and program product to, among other things, determine whether evidence exists for a second content item based on collected evidence from a first scan and, accordingly, based on determining the evidence does exist, skipping a scan for the second content item and using the collected evidence from the first scan as evidence for the second content item. Therefore, the present embodiment has the capacity to improve software development technology by reusing scan results to speed up pipelines.

As previously described, continuous integration (CI) and continuous deployment (CD) are a set of DevOps practices aimed at automating and streamlining the software development lifecycle such as the build, test, and deploy phases. DevSecOps is an extension of the DevOps concept which incorporates security practices/checks into the entire software development lifecycle. Software developers normally commit code multiple times a day while developing a feature or fixing a bug. Automated checks are also in place, such as scans to verify third party libraries/dependencies. In a pull request or CI pipeline, when content being scanned has not changed since a last test, a new scan still runs and collects new evidence, which results in a waste of time and resources. This problem is typically addressed by rerunning scans for only the parts that are unsuccessful without repeating the whole process. However, simply rerunning scans for only the parts that are unsuccessful still requires a rerun which wastes time and resources.

It may therefore be imperative to have a system in place to detect whether a scan can be skipped. Thus, embodiments of the present invention may provide advantages including, but not limited to, reusing scan results to speed up pipelines, intelligently determining whether a scan can be skipped automatically without manual intervention, and optimizing the scan by reusing a result from a previous scan. The present invention does not require that all advantages need to be incorporated into every embodiment of the invention.

According to at least one embodiment, when developing software, a pull request may be received from a user in order to execute a first scan of a first content item corresponding to a first commit as part of a first pipeline. Upon executing the first scan, a first unique ID may be generated for the scanned first content item, where the first unique ID is correlated with collected evidence from the first scan so that upon a merge of the pull request, a second unique ID may be generated for a second content item corresponding to a second commit as part of a second pipeline. Then, it may be determined whether evidence for the second content item exists based on the first unique ID and the second unique ID. Based on determining the evidence exists, the evidence for the second content item may be validated based on one or more validation factors such that based on determining the evidence for the second content item is valid, a second scan may be skipped for the second content item in the second pipeline.

According to at least one other embodiment, based on determining the evidence for the second content item is valid, the collected evidence from the first scan may be used as the evidence for the second content item in order to gate a deployment of an artifact corresponding to the second content item based on the collected evidence from the first scan.

According to at least one further embodiment, based on determining the evidence does not exist, the second scan of the second content item in the second pipeline may be executed, where new evidence is collected for the second content item from the second scan, so that the deployment of the artifact corresponding to the second content item may be gated based on the new evidence from the second scan.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to determine whether evidence exists for a second content item based on collected evidence from a first scan and, accordingly, based on determining the evidence does exist, skipping a scan for the second content item and using the collected evidence from the first scan as evidence for the second content item.

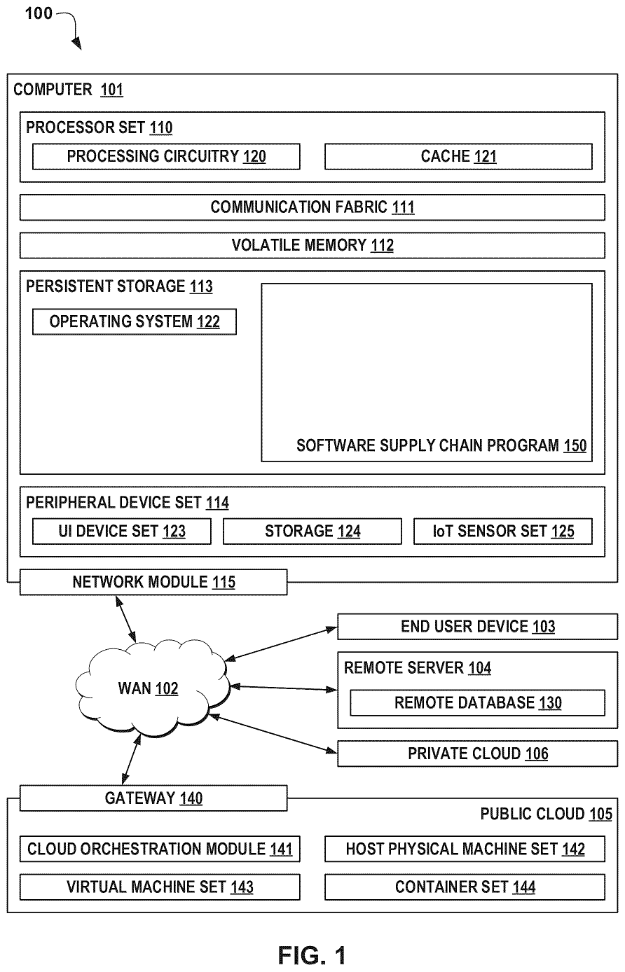

Referring to FIG. 1, an exemplary computing environment 100 is depicted, according to at least one embodiment. Computing environment 100 contains an example of an environment for the execution of at least some of the computer code involved in performing the inventive methods, such as a software supply chain program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

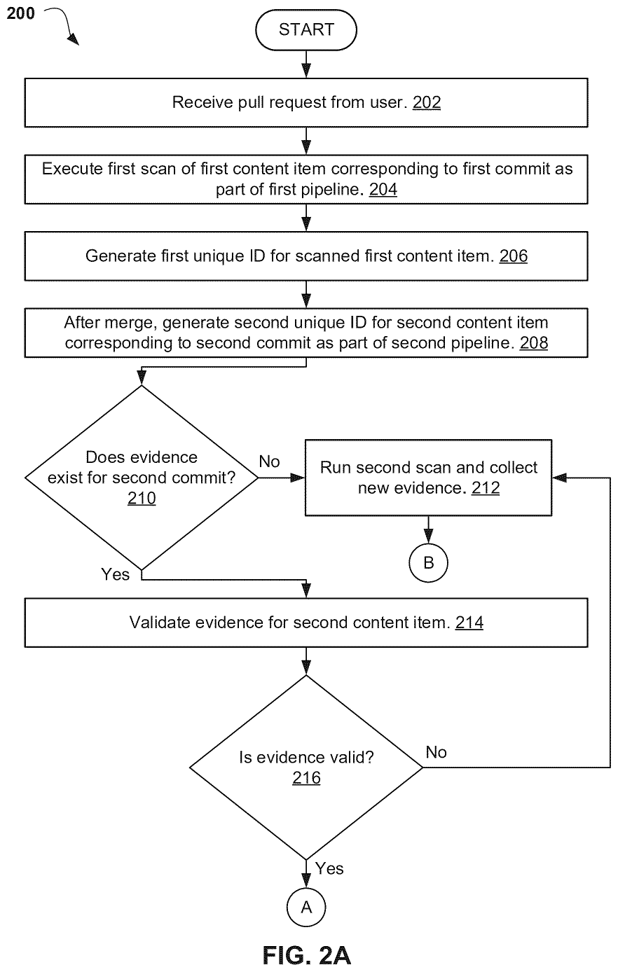

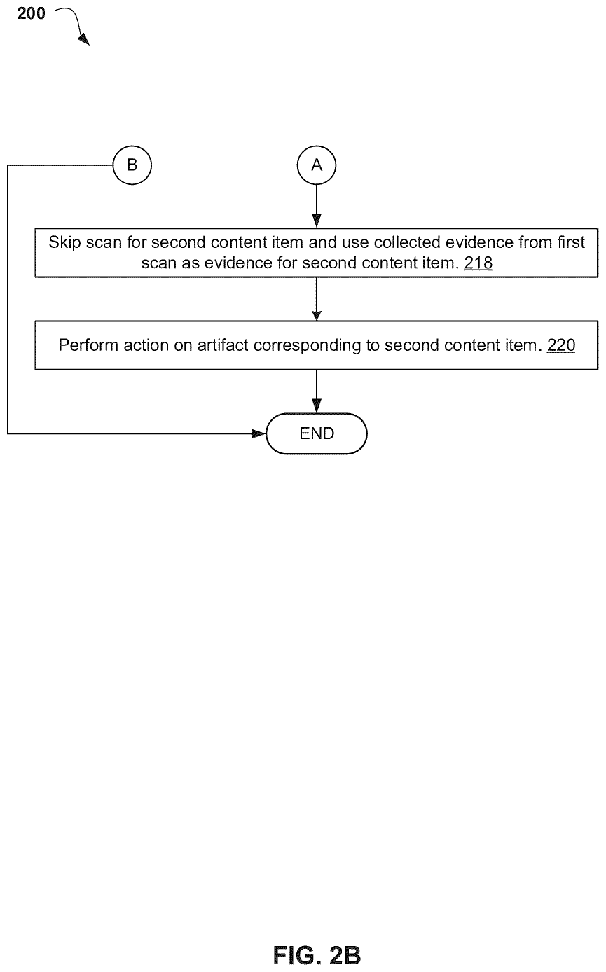

According to the present embodiment, the software supply chain program 150 may be a program capable of receiving a pull request from a user, determining whether evidence exists for a second content item based on collected evidence from a first scan, based on determining the evidence does exist, skipping a scan for the second content item and using the collected evidence from the first scan as evidence for the second content item, reusing scan results to speed up pipelines, intelligently determining whether a scan can be skipped automatically without manual intervention, and optimizing the scan by reusing a result from a previous scan. Furthermore, notwithstanding depiction in computer 101, the software supply chain program 150 may be stored in and/or executed by, individually or in any combination, end user device 103, remote server 104, public cloud 105, and private cloud 106. The software supply chain method is explained in further detail below with respect to FIGS. 2A and 2B. It may be appreciated that the examples described below are not intended to be limiting, and that in embodiments of the present invention the parameters used in the examples may be different.

Referring now to FIGS. 2A and 2B, an operational flowchart for detecting and reusing scan results to optimize a secure software supply chain in a software supply chain optimization process 200 is depicted according to at least one embodiment. At 202, the software supply chain program 150 receives the pull request from the user. The pull request may be a request to merge changes from one branch to another as part of a Gitflow method, typically for code review before merging. The pull request may be raised with, for example, “Commit ID #1.” The pull request may trigger a pull request pipeline or a contiguous integration pipeline, described in further detail below.

Then, at 204, the software supply chain program 150 executes the first scan of the first content item corresponding to the first commit as part of the first pipeline. Examples of the first content item may include, but are not limited to, repository content, a commit, an image (e.g., a container image), and/or any other content items known to one of ordinary skill in the art that are configured to be scanned. The first scan may be executed as a compliance check as part of the first pipeline to detect issues with code changes before the code changes are merged.

According to at least one embodiment, the first pipeline may be a pull request pipeline and the second pipeline may be a continuous integration pipeline. According to at least one other embodiment, the first pipeline and the second pipeline may both be continuous integration pipelines. According to at least one further embodiment, the first pipeline may be a continuous integration pipeline run on one branch in the Gitflow method (e.g., an integration branch) and the second pipeline may be a continuous integration pipeline run on a different branch in the Gitflow method (e.g., a master branch). In the interests of clarity and brevity, the remainder of the disclosure will discuss the first pipeline as being the pull request pipeline and the second pipeline as being the continuous integration pipeline. The first scan may be executed to collect evidences regarding the first content item. The evidences for the first scan and/or any subsequent scan may be an immutable object in a consumable format. The collected evidences may include, but are not limited to, an evidence ID, a date when the evidence was collected, information about which element has been scanned, the scan result (e.g., success/failure), scan logs, and/or any additional metadata providing insights about the security-compliance posture.

For example, the first scan may be a vulnerability scan and the scan may collect evidence as a JavaScript Object Notation (JSON). The collected evidence may be in the following format:
{
“evidence_id”: “evidence-id#1”
“evidence_type”: “vulnerability_scan”
“tool_type”: “CRA”
“asset_id”: “asset-id#1”
“attachments”: “results_file.json”
“date”: “2024-05-21T05:39:29.333Z”
}

Next, at 206, the software supply chain program 150 generates the first unique ID for the scanned first content item. The first unique ID is correlated with the collected evidence from the first scan. The first unique ID may be generated using the sha256 of the repository url and commit ID. For example, the first unique ID may be generated in the following format:
unique-id#1=sha256(repo url, commit-id#1)

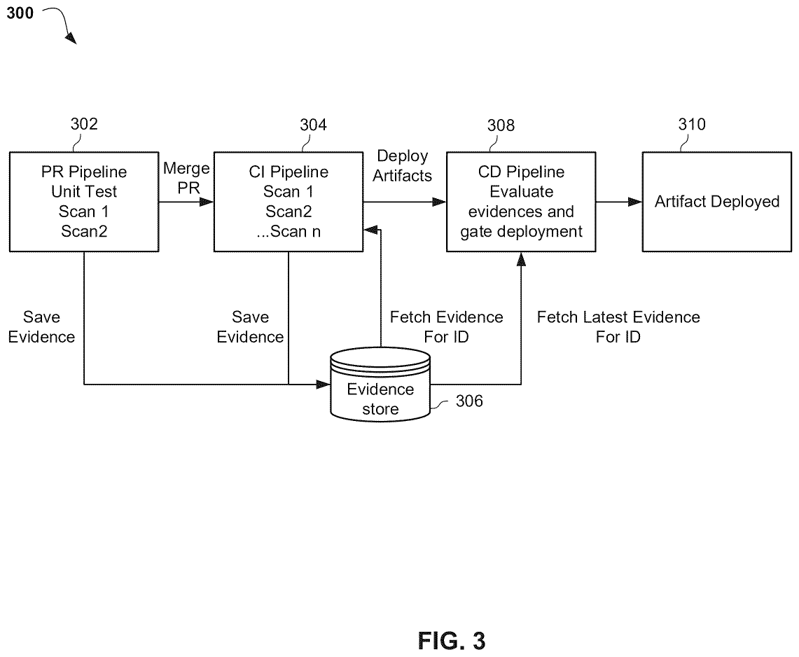

The first unique ID that is correlated with the collected evidence from the first scan may be input into an evidence store, such as the evidence store 306, described in further detail below with respect to the description of FIG. 3. For example, for unique-id#1=sha256(repo url, commit-id#1), the correlated collected evidence in the evidence store 306 may be as follows:
{
“evidence_id”: “evidence-id#1”
“evidence_type”: “vulnerability_scan”
“tool_type”: “CRA”
“asset_id”: “asset-id#1”
“attachments”: “results_file.json”
“date”: “2024-05-21T05:39:29.333Z”
}

Then, at 208, the software supply chain program 150 generates the second unique ID for the second content item corresponding to the second commit as part of the second pipeline. The second unique ID is generated upon a merge of the pull request. The second unique ID may be generated with, for example, “Commit ID #2.” The user may merge the pull request. The second unique ID may be generated using the sha256 of the repository url and commit ID. For example, the second unique ID may be generated in the following format:
unique-id#2=sha256(repo url, commit-id#2)

It may be appreciated that in embodiments of the present invention, the first content item and the second content item may either be the same content item or different content items, described in further detail below. Therefore, the first content item and the second content item should not be construed to be separate content items.

Next, at 210, the software supply chain program 150 determines whether the evidence for the second content item exists. The determination is made based on the first unique ID and the second unique ID.

According to at least one embodiment, the determination the evidence for the second content item exists may be made by identifying a match between the first unique ID and the second unique ID. The first unique ID and the second unique ID may match when the commits between the first pipeline run and the second pipeline run, and therefore the asset IDs, are the same. For example, where the first unique ID is unique-id#1=sha256(repo url, commit-id#1) and the second unique ID is unique-id#1=sha256(repo url, commit-id#1), the determination may be made that the evidence for the second content item exists.

According to at least one other embodiment, even when the determination is made that the first unique ID and the second unique ID do not match, a related ID may be computed, by a GIT application programming interface (API), for the second content item that maps the second content item to the first unique ID when the GIT API detects the first content item and the second content item are substantially identical between the first pipeline and the second pipeline. The first content item and the second content item may be substantially identical when there is no commit between the first commit and the second commit. Additionally, as used herein, “substantially identical” means that minor changes may be made to the first content item and the second content item between the first pipeline and the second pipeline. For example, even when there are repository changes between the first pipeline and the second pipeline, if those changes would have no impact on the scan (e.g., such as an update to a Readme file), the first content item and the second content item may be substantially identical. The related ID may be as follows: related-id=unique-id#1. Using the Git APIs, commit-id#1 may be obtained from commit-id#2, since no other code changes were merged between commit-id#1 and commit-id#2.

In this embodiment, the software supply chain program 150 may check for evidence for unique-id#2 in the evidence store 306 and fetch the evidence for unique-id#2 if found. If the evidence for unique-id#2 is not found, since related-id is the unique-id#1, the software supply chain program 150 may check for evidence for unique-id#1 in the evidence store 306 and fetch the evidence.

According to at least one further embodiment, the evidence for the second content item may not exist when the first content item and the second content item are not substantially identical. The first content item and the second content item may not be substantially identical when there is a direct commit between the commit-id#1 and the commit-id#2. For example, commit-a may be made between the commit-id#1 and the commit-id#2. Continuing the example, commit-id#2 may include code changes of commit-id#1 and commit-a. In this example, there may be no related-id computed. Additionally, the first content item and the second content item may not be substantially identical when the first content item and the second content item are different items of content. For example, the first content item under scan in the first pipeline may be repository content, and the second content item under scan in the second pipeline may be an image.

Based on determining the evidence does not exist (step 210, “No” branch), the software supply chain optimization process 200 proceeds to step 212 to run the second scan and collect new evidence. Based on determining the evidence does exist (step 210, “Yes” branch), the software supply chain optimization process 200 proceeds to step 214 to validate the evidence for the second content item.

Then, at 212, the software supply chain program 150 executes the second scan of the second content item in the second pipeline. The new evidence is collected for the second content item from the second scan. The second unique ID (e.g., unique-id#2=sha256(repo url, commit-id#2) may be correlated with the new evidence and stored in the evidence store 306. For example, for unique-id#2=sha256(repo url, commit-id#2), the new evidence in the evidence store 306 may be as follows:
{
“evidence_id”: “evidence-id#2”
“evidence_type”: “vulnerability_scan”
“tool_type”: “CRA”
“asset_id”: “asset-id#2”
“attachments”: “results_file.json”
“date”: “2024-05-21T06:39:29.333Z”
}

Next, at 214, the software supply chain program 150 validates the evidence for the second content item. The evidence for the second content item is validated based on the one or more validation factors. The one or more validation factors may at least include, but are not limited to, a type of content item and a context of the content item being scanned. As described above, the first content item and the second content item may be the same (e.g., the same image). Additionally, the context of the scans may be the same. The evidence for the second content item may be validated based on determining the first content item and the second content item are the same and a context of the first scan and the second scan are the same. Examples of the context may include, but are not limited to, the scan environment, scan configuration, scanner version, testing tool version, vulnerability database version, and/or pipeline configuration (e.g., pipeline version, acceptance criteria for a scan being changed such as scan acceptance vulnerability being changed from low to medium).

For example, the scan environment may be the same when the first scan is a vulnerability scan and the second scan is also a vulnerability scan. In another example, the testing tool version may be the same when the first scan is conducted with a CRA scanning tool and the second scan is conducted with the CRA scanning tool. In yet another example, the configuration files may be the same when the first scan is conducted with a first version of the configuration files and the second scan is also conducted with the first version of the configuration files. In another example, the pipeline configuration may be the same when the acceptance criteria for the first scan and the second scan remain the same (e.g., acceptance vulnerability severity remaining medium for the first scan and the second scan).

According to at least one embodiment, validating the evidence for the second content item may include computing a staleness of the collected evidence from the first scan. The evidence for the second content item may be valid based on determining the staleness is below a time-frame threshold. As described above, the time at which the first scan is executed may be part of the collected evidence. Thus, the time at which the first scan is executed may be the beginning of the time-frame and the time at which the second scan is to be executed may be the end of the time-frame.

For example, where the time-frame threshold is six hours and the time of the first scan is 2024-05-21T05:39:29 and the time of the second scan is 2024-05-21T06:39:29, the evidence for the second scan may not be stale and the evidence for the second content item may be valid. In another example, where the time-frame threshold is six hours and the time of the first scan is 2024-05-21T05:39:29 and the time of the second scan is 2024-05-22T06:39:29, the evidence for the second scan may be stale and the evidence for the second content item may not be valid.

Then, at 216, the software supply chain program 150 determines whether the evidence for the second content item is valid. As described above with respect to step 214, the evidence for the second content item may be deemed valid based on determining the first content item and the second content item are the same and a context of the first scan and the second scan are the same, and several examples were provided for determining whether the context was the same.

The evidence for the second content item may not be valid when the context for the first content item and the context for the second content item are not the same. For example, the scan environment may not be the same when the first scan is a vulnerability scan and the second scan is a different type of scan. In another example, the testing tool version may not be the same when the first scan is conducted with a CRA scanning tool and the second scan is conducted with a different scanning tool. In yet another example, the configuration files may not be the same when the first scan is conducted with a first version of the configuration files and the second scan is conducted with a second version of the configuration files. In another example, the pipeline configuration may not be the same when the acceptance criteria for the first scan and the second scan has changed (e.g., acceptance vulnerability severity changing from medium for the first scan to high for the second scan).

Based on determining the evidence for the second content item is valid (step 216, “Yes” branch), the software supply chain optimization process 200 proceeds to step 218 to skip the second scan for the second content item in the second pipeline. Based on determining the evidence for the second content item is not valid (step 216, “No” branch), the software supply chain optimization process 200 reverts back to step 212 to run the second scan and collect new evidence.

Next, at 218, the software supply chain program 150 skips the second scan for the second content item in the second pipeline. The collected evidence from the first scan may be used as the evidence for the second content item. For example, the collected evidence from the first scan that may be used as the evidence for the second content item may be as follows:
{
“evidence_id”: “evidence-id#1”
“evidence_type”: “vulnerability_scan”
“tool_type”: “CRA”
“asset_id”: “asset-id#1”
“attachments”: “results_file.json”
“date”: “2024-05-21T05:39:29.333Z”
}

Then, at 220, an action is performed on an artifact corresponding to the second content item. As used herein, “artifact” means any byproduct produced during the software development process. Examples of the artifact may include, but are not limited to, a document, code file, diagram, and/or executable program.

According to at least one embodiment, the action performed on the artifact may be to gate the deployment of the artifact corresponding to the second content item based on the collected evidence from the first scan. In this embodiment, the evidence may exist for the second content item and the evidence for the second content item may be deemed valid. The evidence for the second item may be evaluated and based on the evaluation, deployment of the artifact may be gated. For example, the deployment of the artifact may be gated when the collected evidence from the first scan indicates vulnerabilities the artifact may have in view of certain threats.

According to at least one other embodiment, the action performed on the artifact may be to gate the deployment of the artifact corresponding to the second content item based on the new evidence from the second scan. In this embodiment, the evidence may either not exist for the second content item or the evidence for the second content item may be deemed invalid. The new evidence for the second item may be evaluated and based on the evaluation, deployment of the artifact may be gated. For example, the deployment of the artifact may be gated when the new evidence from the second scan indicates vulnerabilities the artifact may have in view of certain threats.

Referring now to FIG. 3, an exemplary diagram 300 depicting an interaction between solution components of the process in FIGS. 2A and 2B is shown according to at least one embodiment. In the diagram 300, a pull request (PR) pipeline module 302 may run the first scan of the first content item and collect evidence from the first scan. For example, the first scan may include a plurality of first scans, such as Scan 1 and Scan 2. The collected evidence from the first scan may be stored in the evidence store 306. Once the PR is merged, a continuous integration (CI) module 304 may be triggered which may run the second scan for the second content item. For example, the second scan may include a plurality of scans, such as Scan 1, Scan 2, and . . . Scan n, where n=the number of scans. Based on determining either the evidence for the second content item does not exist or the evidence is invalid, the second scan may obtain new evidence for the second content item. The new evidence for the second content item may also be stored in the evidence store 306. Then, a continuous deployment (CD) module 308 may fetch the latest evidence for the second content item from the evidence store 306. The latest evidence may be the collected evidence from the first scan when no second scan is executed for the second content item. Alternatively, the latest evidence may be the new evidence from the second scan when the second scan is executed for the second content item. The CD module 308 may evaluate the latest evidence and gate the deployment of the artifact when vulnerabilities are detected. Contrarily, an artifact deployment module 310 may deploy the artifact when the latest evidence indicates few or no vulnerabilities.

It may be appreciated that FIGS. 2A, 2B, and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of detecting and reusing scan results to optimize a secure software supply chain, the method comprising:
receiving a pull request from a user;
executing a first scan of a first content item corresponding to a first commit as part of a first pipeline;
generating a first unique ID for the scanned first content item, wherein the first unique ID is correlated with collected evidence from the first scan;
upon a merge of the pull request, generating a second unique ID for a second content item corresponding to a second commit as part of a second pipeline; and
determining whether evidence for the second content item exists based on the first unique ID and the second unique ID;
based on determining the evidence exists:
validating the evidence for the second content item based on one or more validation factors; and
based on determining the evidence for the second content item is valid, skipping a second scan for the second content item in the second pipeline.

2. The computer-based method of claim 1, further comprising:
using the collected evidence from the first scan as the evidence for the second content item; and
gating a deployment of an artifact corresponding to the second content item based on the collected evidence from the first scan.

3. The computer-based method of claim 1, further comprising:
based on determining the evidence does not exist:
executing the second scan of the second content item in the second pipeline, wherein new evidence is collected for the second content item from the second scan; and
gating a deployment of an artifact corresponding to the second content item based on the new evidence from the second scan.

4. The computer-based method of claim 1, wherein determining whether the evidence for the second content item exists further comprises:
determining whether the first unique ID and the second unique ID match; and
based on determining the first unique ID and the second unique ID do not match, computing a related ID, by a GIT application programming interface (API), for the second content item that maps the second content item to the first unique ID when the GIT API detects the first content item and the second content item are substantially identical between the first pipeline and the second pipeline.

5. The computer-based method of claim 1, wherein validating the evidence for the second content item further comprises:
computing a staleness of the collected evidence from the first scan, wherein the evidence for the second content item is valid based on determining the staleness is below a time-frame threshold.

6. The computer-based method of claim 1, wherein the first pipeline is a pull request pipeline and the second pipeline is a continuous integration pipeline.

7. The computer-based method of claim 1, wherein the first pipeline and the second pipeline are continuous integration pipelines.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a pull request from a user;
executing a first scan of a first content item corresponding to a first commit as part of a first pipeline;
generating a first unique ID for the scanned first content item, wherein the first unique ID is correlated with collected evidence from the first scan;
upon a merge of the pull request, generating a second unique ID for a second content item corresponding to a second commit as part of a second pipeline; and
determining whether evidence for the second content item exists based on the first unique ID and the second unique ID;
based on determining the evidence exists:
validating the evidence for the second content item based on one or more validation factors; and
based on determining the evidence for the second content item is valid, skipping a second scan for the second content item in the second pipeline.

9. The computer system of claim 8, the method further comprising:
using the collected evidence from the first scan as the evidence for the second content item; and
gating a deployment of an artifact corresponding to the second content item based on the collected evidence from the first scan.

10. The computer system of claim 8, the method further comprising:
based on determining the evidence does not exist:
executing the second scan of the second content item in the second pipeline, wherein new evidence is collected for the second content item from the second scan; and
gating a deployment of an artifact corresponding to the second content item based on the new evidence from the second scan.

11. The computer system of claim 8, wherein determining whether the evidence for the second content item exists further comprises:
determining whether the first unique ID and the second unique ID match; and
based on determining the first unique ID and the second unique ID do not match, computing a related ID, by a GIT application programming interface (API), for the second content item that maps the second content item to the first unique ID when the GIT API detects the first content item and the second content item are substantially identical between the first pipeline and the second pipeline.

12. The computer system of claim 8, wherein validating the evidence for the second content item further comprises:
computing a staleness of the collected evidence from the first scan, wherein the evidence for the second content item is valid based on determining the staleness is below a time-frame threshold.

13. The computer system of claim 8, wherein the first pipeline is a pull request pipeline and the second pipeline is a continuous integration pipeline.

14. The computer system of claim 8, wherein the first pipeline and the second pipeline are continuous integration pipelines.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a pull request from a user;
executing a first scan of a first content item corresponding to a first commit as part of a first pipeline;
generating a first unique ID for the scanned first content item, wherein the first unique ID is correlated with collected evidence from the first scan;
upon a merge of the pull request, generating a second unique ID for a second content item corresponding to a second commit as part of a second pipeline; and
determining whether evidence for the second content item exists based on the first unique ID and the second unique ID;
based on determining the evidence exists:
validating the evidence for the second content item based on one or more validation factors; and
based on determining the evidence for the second content item is valid, skipping a second scan for the second content item in the second pipeline.

16. The computer program product of claim 15, the method further comprising:
using the collected evidence from the first scan as the evidence for the second content item; and
gating a deployment of an artifact corresponding to the second content item based on the collected evidence from the first scan.

17. The computer program product of claim 15, the method further comprising:
based on determining the evidence does not exist:
executing the second scan of the second content item in the second pipeline, wherein new evidence is collected for the second content item from the second scan; and
gating a deployment of an artifact corresponding to the second content item based on the new evidence from the second scan.

18. The computer program product of claim 15, wherein determining whether the evidence for the second content item exists further comprises:
determining whether the first unique ID and the second unique ID match; and
based on determining the first unique ID and the second unique ID do not match, computing a related ID, by a GIT application programming interface (API), for the second content item that maps the second content item to the first unique ID when the GIT API detects the first content item and the second content item are substantially identical between the first pipeline and the second pipeline.

19. The computer program product of claim 15, wherein validating the evidence for the second content item further comprises:
computing a staleness of the collected evidence from the first scan, wherein the evidence for the second content item is valid based on determining the staleness is below a time-frame threshold.

20. The computer program product of claim 15, wherein the first pipeline is a pull request pipeline and the second pipeline is a continuous integration pipeline.
